(19) United States
(12) Patent Application Publication
(10) Pub. No.: US 2022/0018670 A1
(43) Pub. Date: Jan. 20, 2022

(54) ROUTE GUIDANCE SYSTEM, TERMINAL, ROUTE GUIDANCE METHOD AND PROGRAM

(71) Applicant: NEC Corporation, Minato-ku, Tokyo (JP)

(72) Inventor: Takuji NISHINO, Tokyo (JP)

(73) Assignee: NEC Corporation, Minato-ku, Tokyo (JP)

(21) Appl. No.: 17/294,483

(22) PCT Filed: Nov. 18, 2019
(86) PCT No.: PCT/JP2019/045020

§ 371 Date: May 17, 2021

(30) Foreign Application Priority Data
Nov. 19, 2018 (JP) 2018-216477

(51) Int. Cl. G01C 21/34

(52) U.S. Cl. CPC G01C 21/3461; G01C 21/3484

(57) ABSTRACT

A route evaluation part of a route guidance system stores, in a case where a route that does not match with a priority condition among multiple presented routes is selected, a distance-difference between a distance of the route that matches with the priority condition and a distance of the selected route as weight information of the priority condition. In addition, the route evaluation part presents, upon presenting a route at the next and subsequent timings, a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

### CROSS-REFERENCE TO RELATED APPLICATION

This application is a National Stage Entry of PCT/JP2019/045020 filed on Nov. 18, 2019, which claims priority from Japanese Patent Application 2018-216477 filed on Nov. 19, 2018, the contents of all of which are incorporated herein by reference, in their entirety. The present invention relates to a route guidance system, a terminal, a route guidance method and a program.

### FIELD

### Background

Patent Literature 1 (PTL 1) discloses a method of providing route guidance suitable for individual situation for each user by comprehensively considering facilities in a building, function or condition thereof, property or authority of the user, a visiting destination or a visiting purpose, and the like. In the method disclosed in the same literature, the route guidance is provided using data referred to as building-information-modeling (BIM) data. More concretely, a computer disclosed in the same literature creates a route based on BIM data, security information on the route, and user's profile of a user who uses the route guidance. In addition, the same literature, paragraph 0074, exemplifies user properties. According to the paragraph 0074, listed are user's sexuality, age or age level, preference (for example, priority on either of escalator or elevator), a pregnant woman, use or no-use of a baby carriage, use or no-use of wheelchair or crutch, and the like.

Patent Literature 2 (PTL 2) discloses a method of creating a ranking of recommendations for a walker environment. Concretely, the same literature discloses a location-aware recommendation engine that creates a ranking of relating recommendations as a response to a recommendation request based on a current location of a user, a location relating to an entity, and/or an access possibility criterion.

Patent Literature 3 (PTL 3) discloses a navigation system specialized to a person, in which route search is executed under consideration of walker's safety. The same literature discloses a configuration where walkway data is used as electric map data used for electrical route search, in which connection state of actual walkways is presented with link data indicating walkways and node data indicating connection points or endpoints of walkways. The same literature discloses that surrounding cost data indicating walkway safety depending on surrounding situation of a walkway is used. In addition, it is disclosed that a safe route is searched based on walker's properties by using electric map data that stores the surrounding cost data in association with each link data for every walker's classes which are classified under consideration of at least one among walker's sexuality and age.
PTL 1: WO2014/132802A
PTL 2: Tokkai JP2014-160093A
PTL 3: Tokkai JP 2007-41005A

### SUMMARY

The following analyses have been given by the present invention. Patent Literature 1 to 3 disclose a variety of route guidance apparatuses (navigation systems) for a walker. However, there is a problem that they cannot provide route guidance in which detail preferences of the user relating to movement (walk, travel) are reflected. For example, there are a person who prefers elevator-use absolutely, a person who prefers escalator-use absolutely, as well as a person who basically prefers elevator-use, but would select escalator-use if total distance to a destination place by walking is extended.

It is a purpose of the present invention to provide a route guidance system, a terminal, a route guidance method and a program, which guide a route reflecting the above stated detail prefences or necessity of individual users so as to contribute to improvement in convenience thereof.

According to a first aspect, there is provided a route guidance system comprising a setting reception part that receives a setting of a priority condition for a route other than the distance of the route from a user terminal. The route guidance system further comprises a route search part that searches a plurality of routes allowing to reach a destination place from a departure place based on map information including a map for route calculation, and the departure place and the destination place that are input from the terminal. The route guidance system further comprises a route evaluation part that determines whether, or not, the searched route matches with the priority condition so as to present, side-by-side, a route(s) that matches with the priority condition and a route(s) that does not match with the priority condition. The route guidance system further comprises a guidance part that receives selection of a route from the terminal so as to execute route guidance. More concretely, in a case where a route that does not match with the priority condition among the presented routes is selected, the route evaluation part stores, as weight information of the priority condition, a distance-difference between a distance of the route that matches with the priority condition and a distance of the selected route. In addition, the route evaluation part presents, upon presenting a route at the next and subsequent timings, a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

According to a second aspect, there is provided a terminal, comprising: a setting reception part that receives a setting of a priority condition for a route other than the distance of the route from a user; a route search part that searches a plurality of routes allowing to reach a destination place from a departure place based on map information including a map for route calculation, and the departure place and the destination place that are input from the user; a route evaluation part that determines whether, or not, the searched route matches with the priority condition so as to present, side-by-side, a route(s) that matches with the priority condition and a route(s) that does not match with the priority condition; and a guidance part that receives selection of a route from the user so as to execute route guidance; wherein, in a case where a route that does not match with the priority condition among the presented routes is selected, the route evaluation part stores, as weight information of the priority condition, a distance-difference between a distance of the route that matches with the priority condition and a distance of the selected rout, and the route evaluation part presents, upon presenting a route at the next and subsequent timings, a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

According to a third aspect, there is provided a route guidance method, comprising: receiving a setting of a priority condition for a route other than the distance of the route from a user; searching a plurality of routes allowing to reach a destination place from a departure place based on map information including a map for route calculation, and the departure place and the destination place that are input from the user; determining whether, or not, the searched route matches with the priority condition so as to present, side-by-side, a route(s) that matches with the priority condition and a route(s) that does not match with the priority condition; receiving selection of a route from a user so as to execute route guidance; and storing, in a case where a route that does not match with the priority condition among the presented routes is selected, as weight information of the priority condition, a distance-difference between a distance of the route that matches with the priority condition and a distance of the selected route. The route guidance method further, upon presenting a route at the next and subsequent timings, presents a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information. The route guidance method is associated with a specific machine as a route guidance apparatus that executes route guidance to a user terminal.

According to a fourth aspect, there is provided a route guidance program that causes a computer functioning as a route guidance apparatus to execute: a process of receiving a setting of a priority condition for a route other than the distance of the route from a user; a process of searching a plurality of routes allowing to reach a destination place from a departure place based on map information including a map for route calculation, and the departure place and the destination place that are input from the user; a process of determining whether, or not, the searched route matches with the priority condition so as to present a plurality of routes in a mode where a route(s) that matches with the priority condition is recommended; a process of receiving selection of a route from the user so as to execute route guidance; and a process of storing a distance-difference between a distance of the route that matches with the priority condition and a distance of the selected route as weight information of the priority condition in a case where a route that does not match with the priority condition among the presented routes is selected; wherein, upon presenting a route at the next and subsequent timings, a route is presented in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information. Herein, the program may be stored in a (non-transitory) storage medium readable by a computer. That is, the present invention may be realized as a computer program product.

According to the present invention, it is possible to provide route guidance to which detail preferences or necessity of individual users are reflected. That is, the present invention is one which converts the route guidance systems described in the background to one having a dramatically improved performance on an aspect of route presentation function.

### BRIEF DESCRIPTION OF THE DRAWINGS

FIG. 1 is a diagram showing a configuration of one example embodiment of the present invention.

FIG. 2 is an explanatory view of operations of one example embodiment of the present invention.

FIG. 3 is an explanatory view of operations of one example embodiment of the present invention.

FIG. 4 is an explanatory view of operations of one example embodiment of the present invention.

FIG. 5 is an explanatory view of operations of one example embodiment of the present invention.

FIG. 6 is an explanatory view of operations of one example embodiment of the present invention.

FIG. 7 is an explanatory view of operations of one example embodiment of the present invention.

FIG. 8 is a diagram showing a configuration of a route guidance system of a first example embodiment of the present invention.

FIG. 9 is a functional block diagram showing a configuration of a route guidance apparatus of the first example embodiment of the present invention.

FIG. 10 is a functional block diagram showing a configuration of a route evaluation apparatus of the first example embodiment of the present invention.

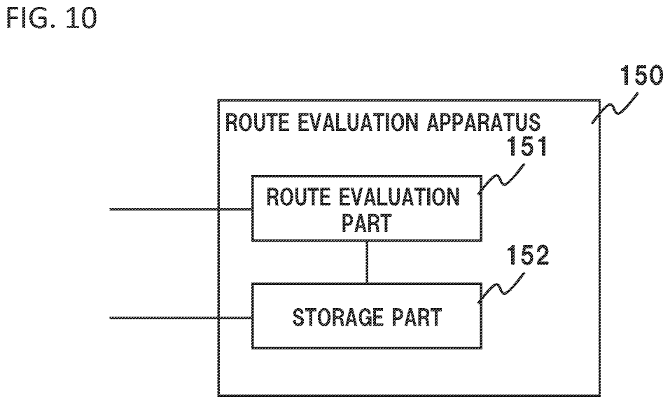

FIG. 11 is a conceptual view illustrating flow of information in the route guidance system of the first example embodiment of the present invention.

FIG. 12 is a flowchart illustrating operations by the route guidance system of the first example embodiment of the present invention.

FIG. 13 is a diagram showing a configuration of a computer configuring the route guidance system of the present invention.

### PREFERRED MODES

First, an outline of one example embodiment is explained while referring to drawings. Herein, reference signs described in the outline is expediently appended to each element as one example for an aid for understanding. It is not intended to limit the present invention to the mode illustrated in the drawings. In addition, a connection line between blocks in each drawing and the like referred to in the following explanation includes both of bidirectional and monodirectional connections. One-way arrow schematically indicates a main signal (data) flow, but not excluding bidirectional flows. Further, although omitted in the diagrams, a connection point of input/output of each block illustrated in the drawings comprises a port and an interface. A program is executed by a computer apparatus. The computer apparatus comprises, for example, a processor, a storage device, an input device, a communication interface and a display device, if required. In addition, the computer apparatus is configured to be capable of communicating with an internal or external apparatus (including a computer) via a communication interface irrespective of cable communication or radio communication. Further, in the following explanation, a phrase “A and/or B” is used for referring to any of “A or B” or “A and B”.

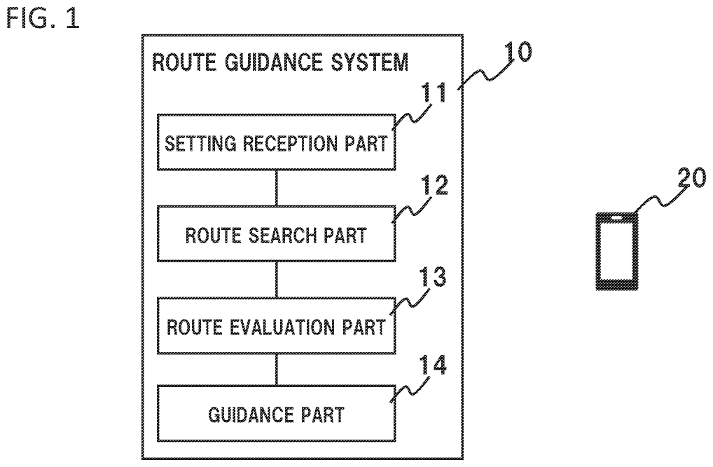

In one example embodiment, as illustrated in FIG. 1, the present invention may be realized by a route guidance system 10 comprising a setting reception part 11, a route search part 12, a route evaluation part 13 and a guidance part 14. More concretely, the setting reception part 11 receives a setting of a priority condition for a route other than the distance of the route from a user's terminal 20. The route search part 12 searches a plurality of routes allowing to reach a destination place from a departure place based on map information including a map for route calculation, and the departure place and the destination place that are input from the terminal. The route evaluation part 13 determines whether, or not, the searched route matches with the priority condition so as to present, side-by-side, a route(s) that matches with the priority condition and a route(s) that does not match with the priority condition. In addition, the guidance part 14 receives selection of a route from the terminal so as to execute route guidance.

Further, in a case where a route that does not match with the priority condition among the presented routes is selected, the route evaluation part 13 stores, as weight information of the priority condition, a distance-difference between a distance of the route that matches with the priority condition and a distance of the selected route. In addition, the route evaluation part 13 presents, upon presenting a route at the next and subsequent timings, a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

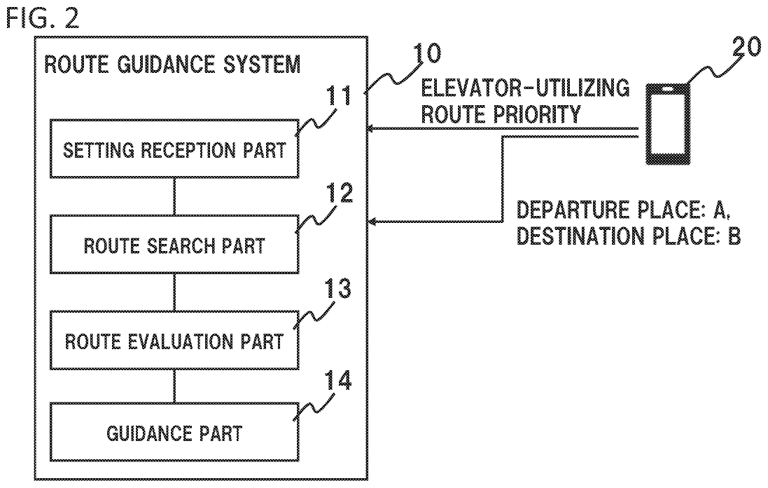

Operations by the route evaluation part 13 are explained while referring to a concreate example. For example, as illustrated in FIG. 2, it is explained with an assumption that the terminal 20 has requested the route guidance system 10 to execute route guidance under a priority condition of DEPARTURE PLACE: A, DESTINATION PLACE: B, and “taking priority on elevator-utilizing route” [hereinafter, referred to as “ELEVATOR-UTILIZING ROUTE PRIORITY”]. In addition, the priority condition may be previously registered by a user, but not designated every timing (execution) of route search. Furthermore, position information of the terminal 20 obtained from GPS (Global Positioning System) may be used as DEPARTURE PLACE: A.

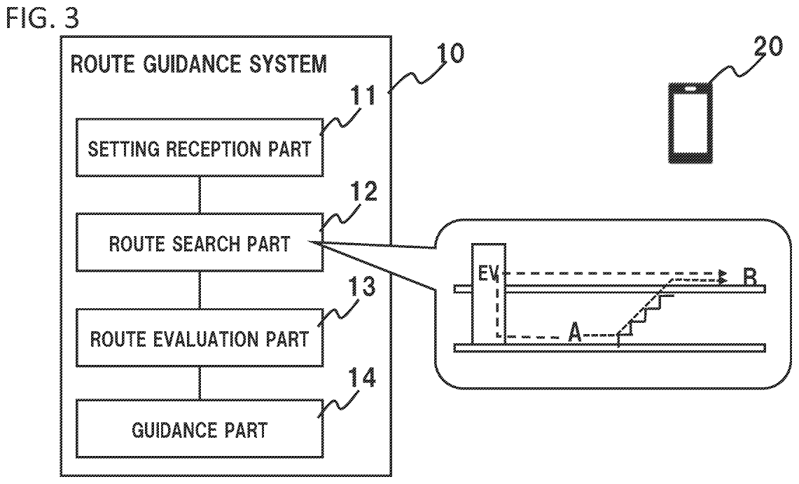

The route search part 12 that received input of the departure place and the destination place refers to map information including a map for route calculation and searches a plurality of routes allowing to reach a destination place from a departure place. Herein, as illustrated at right side of FIG. 3, it is assumed that: DEPARTURE PLACE: A is a certain place on a lower floor; DESTINATION PLACE: B is a certain place on an upper floor; and two routes of an elevator (EV)-utilizing route and a steps-utilizing route have been searched.

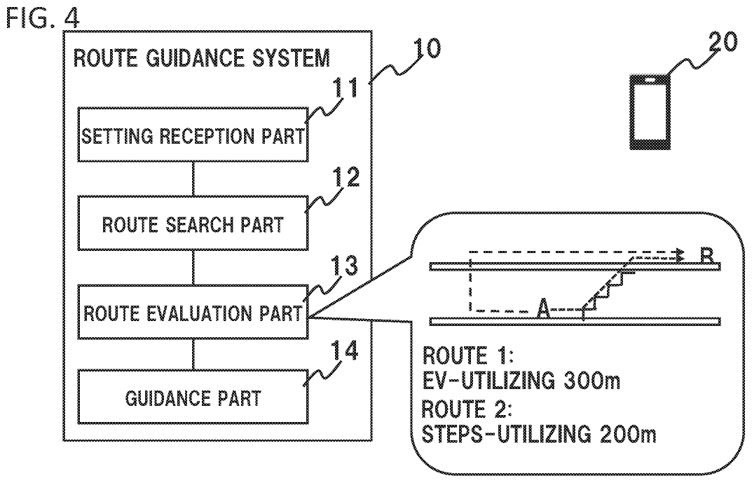

Next, the route evaluation part 13 determines whether, or not, the searched route matches with the priority condition. Herein, as illustrated in FIG. 4, since the two routes of the elevator (EV)-utilizing route and the steps-utilizing route have been found, the route evaluation part 13 presents, side-by-side, ROUTE 1: ELEVATOR (EV)-UTILIZING ROUTE and ROUTE 2: STEPS-UTILIZING ROUTE. Hereinafter, in the present example, it is assumed that the user has selected the STEPS-UTILIZING ROUTE (200 m) whose distance is shorter than that of the ELEVATOR (EV)-UTILIZING ROUTE (300 m).

In such case, the route evaluation part 13 stores 100 m indicating a distance-difference between the ROUTE 1: ELEVATOR (EV)-UTILIZING ROUTE (300 m) and the ROUTE 2: STEPS-UTILIZING ROUTE (200 m) as weight information for the priority condition (ELEVATOR-UTILIZING ROUTE PRIORITY).

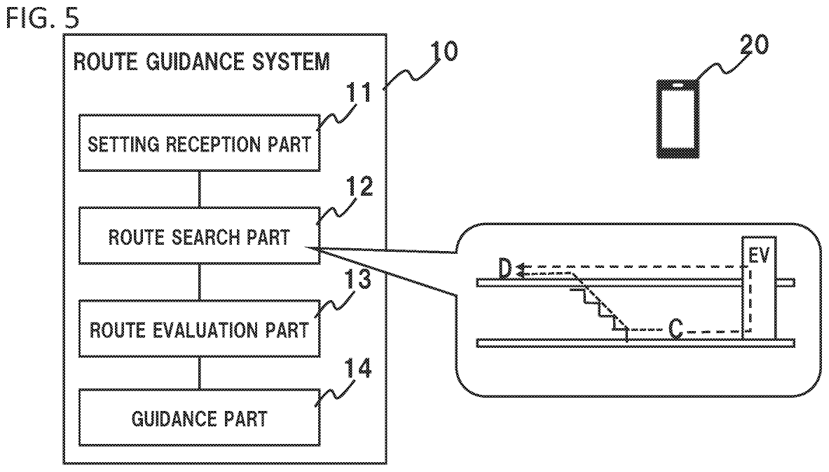

After that, upon presentation of routes, the route evaluation part 13 presents a route in a mode where a route(s) that does not match with the priority condition [also referred to as “non-matching route”] is recommended rather than a route(s) that matches with the priority condition [also referred to as “matching route”] in a case where a distance-difference between the distance of the matching route and the distance of the non-matching route exceeds the distance stored as the weight information. For example, it is assumed that the same user had requested route guidance under a priority condition of DEPARTURE PLACE: C, DESTINATION PLACE: D, and “ELEVATOR-UTILIZING ROUTE PRIORITY”, and two routes illustrated at right side of FIG. 5 have been found.

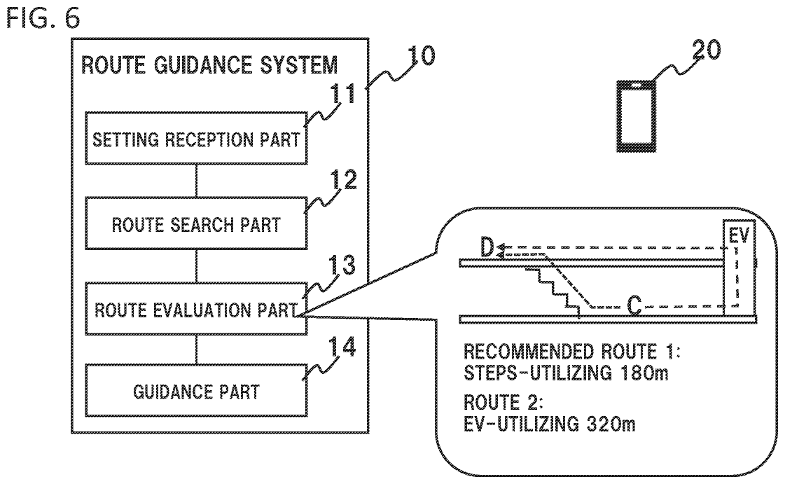

Herein, as illustrated in FIG. 6, assumed a case where the distance of an ELEVATOR (EV)-UTILIZING ROUTE (ROUTE 2) is 320 m and the distance of a STEPS-UTILIZING ROUTE is 180 m, the distance-difference results in 140 m. Since 140 m as the distance-difference exceeds 100 m as the distance stored as the weight information, the route evaluation part 13 presents the routes in a mode where the STEPS-UTILIZING ROUTE is recommended rather than the ELEVATOR (EV)-UTILIZING ROUTE that matches with the priority condition. Thereby, the user becomes capable to immediately select a route matching with an own behavior pattern that he utilizes steps under a situation of exceeding a distance-difference at a certain extent.

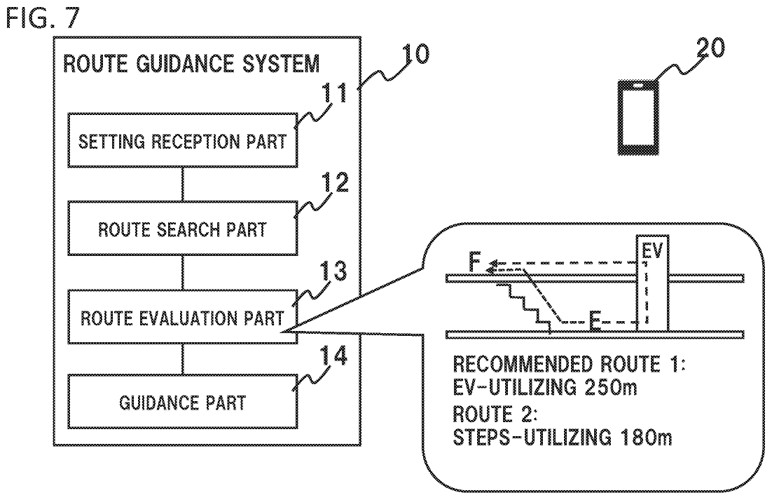

On the other hand, in a case where the same user had requested route guidance under a priority condition of DEPARTURE PLACE: E, DESTINATION PLACE: F, and “ELEVATOR-UTILIZING ROUTE PRIORITY” and two routes illustrated at right side of FIG. 7 have been found, a recommended route results in an ELEVATOR (EV)-UTILIZING ROUTE. As a reason for such route guidance, in the case of FIG. 7, since the distance of the ELEVATOR (EV)-UTILIZING ROUTE (ROUTE 1) is 250 m and the distance of a STEPS-UTILIZING ROUTE is 180 m, a distance-difference therebetween results in 70 m. Such selection of a route matches with the user's behavior pattern that the user wishes to utilize an elevator (EV) under a situation of within a distance-difference at a certain extent.

As explained above, according to the present example embodiment, it becomes possible to prospect a user's intention determination pattern (preference) using a past route selection result(s) by a user so as to execute recommendation of a route based on the result(s). Herein, various modes may be considered as a mode where a non-matching route is recommended. For example, various modes may be adopted, such as presenting it at an upper rank in a ranking, displaying it in an emphasized state, attaching a message, such as “Recommendation” and the like.

### First Example Embodiment

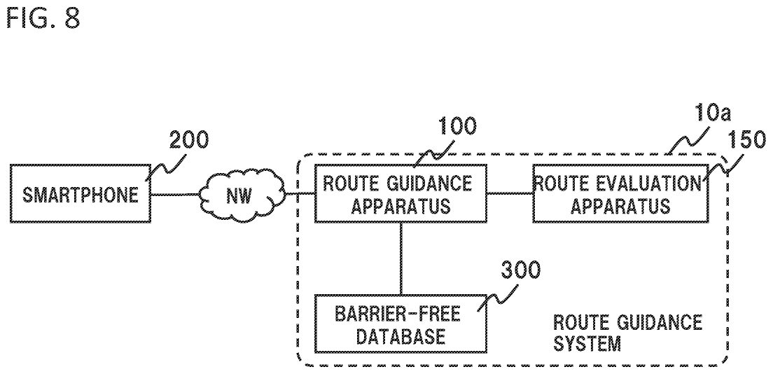

Next, a first example embodiment of the present invention is explained in detail while referring to drawings. FIG. 8 is a diagram showing a construction of a route guidance system of the first example embodiment of the present invention. FIG. 8 shows a route guidance system 10a comprising at least one route evaluation apparatus 150, at least one barrier-free database 300, and at least one route guidance apparatus 100. The route guidance system 10a provides a map information service and a route guidance service to a smartphone 200 via a network (NW). Herein, although the route evaluation apparatus 150, the barrier-free database 300 and the route guidance apparatus 100 are assumed to be connected via the network in the following explanation, they may coexist on the same platform.

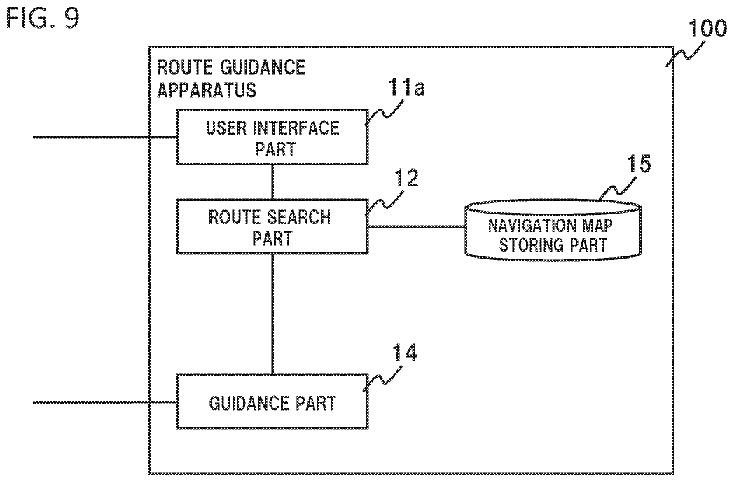

The route guidance apparatus 100 has a cooperating function with the route evaluation apparatus 150 and the barrier-free database 300. FIG. 9 is a functional block diagram showing a construction of the route guidance apparatus 100. Referring to FIG. 9, the route guidance apparatus 100 comprises a user interface part 11a, a route search part 12, a guidance part 14 and a navigation map storing part 15. The user interface part 11a receives, from a user of the smartphone 200, priority condition(s), such as a start point and an end point (a departure place and a destination place) for route guidance, taking priority on an elevator [i.e., ELEVATOR-UTILIZING ROUTE PRIORITY], taking priority on an elevator or an escalator [i.e., ELEVATOR- OR ESCALATOR-UTILIZING ROUTE PRIORITY], and taking priority on steps-utilizing [i.e., STEPS-UTILIZING ROUTE PRIORITY]. The user interface part 11a corresponds to the setting reception part 11 described above. The priority condition will be explained later on.

The route search part 12 refers to a route guidance map stored in the navigation map storing part 15 so as to search a route from the start point (departure place) to the end point (destination place) that have been received from the user interface part 11a. The methods of Patent Literature 1 to 3 may be used as a method of searching a route in the route search part 12, too.

The navigation map storing part 15 stores a route guidance map. A combination of map data for route calculation in which a passageway is represented by a link and a connection point of passageways and an end point are represented by a node as disclosed in Patent Literature 3 and map data for presenting to a user may be used as the route guidance map.

The guidance part 14 executes route guidance based on a route that is selected by a user of the smartphone 200.

The smartphone 200 executes transmission/reception of information to/from the route guidance apparatus 100 via an installed route guidance application program (hereinafter, referred to as “application”). Herein, although only the smartphone 200 is illustrated in FIG. 8, the other terminals may access the route guidance apparatus 100 so as to receive provision of the route guidance service. For example, a personal computer and a specific navigation terminal may access the route guidance apparatus 100 so as to receive provision of the route guidance service.

The route evaluation apparatus 150 has a cooperating function with the route guidance apparatus 100 and refers to information, etc. in the barrier-free database 300 which is received from the route guidance apparatus 100 so as to execute evaluation of a route created by the route guidance apparatus 100.

More concretely, the route evaluation apparatus 150 comprises a route evaluation part 151 and a storage part 152. In the storage part 152, a user database is constructed and the priority condition for each user is stored. The route evaluation part 151 executes evaluation of route candidates received from the route guidance apparatus 100 and also executes update of an evaluation logic in accordance with user's priority condition based on route information selected by a user. The update of the evaluation logic by the route evaluation part 151 will be explained in detail later on.

The barrier-free database 300 is a database that stores roads on a map, barrier information in a facility, and facility information for handicapped persons. The barrier information includes, for example, an elevator, an escalator, a slope, a pedestrian bridge, steps on a passageway and a type of road surface, as well as detail information thereof. As the detail information, exemplified are slope gradient, presence/absence of a handrail, the number of steps of a pedestrian bridge and stairs, and the height of one step.

Herein, although it is considered that the route evaluation apparatus 150 and the barrier-free database 300 are held and managed by the same service provider as that of the route guidance apparatus 100, a configuration may be adopted where another service provider holds and manages them. In such case, it is assumed that each of the route evaluation apparatus 150 and the barrier-free database 300 provides required information to the route guidance apparatus 100.

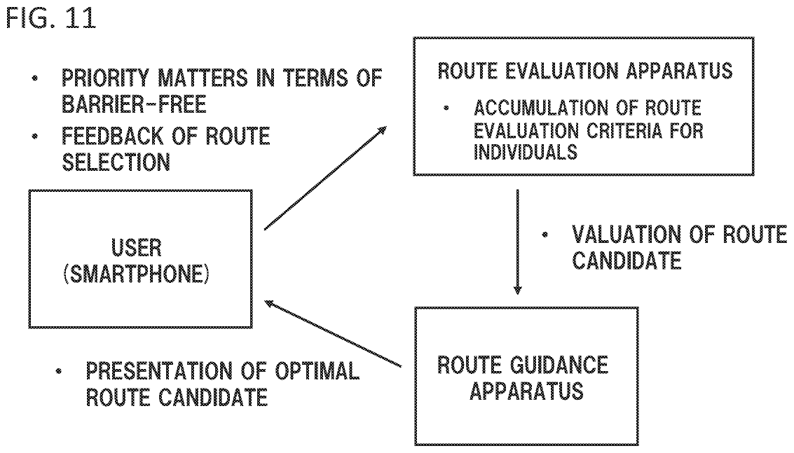

FIG. 11 is a conceptual view illustrating flows of information in the route guidance system of the first example embodiment of the present invention. Referring to FIG. 11, a user (smartphone 200) provides the route evaluation apparatus 150 with the priority condition, that is priority matters in terms of barrier-free and a result of route selection (feedback).

The route evaluation apparatus 150 evaluates a route (candidate routes) based on the priority condition received from the user (smartphone 200), i.e., the priority matters in route search and the result of route selection (feedback). The route evaluation apparatus 150 transmits an evaluation result of the route (candidate routes) to the route guidance apparatus 100.

The route guidance apparatus 100 presents route candidates including an optimal route candidate to the user (smartphone 200).

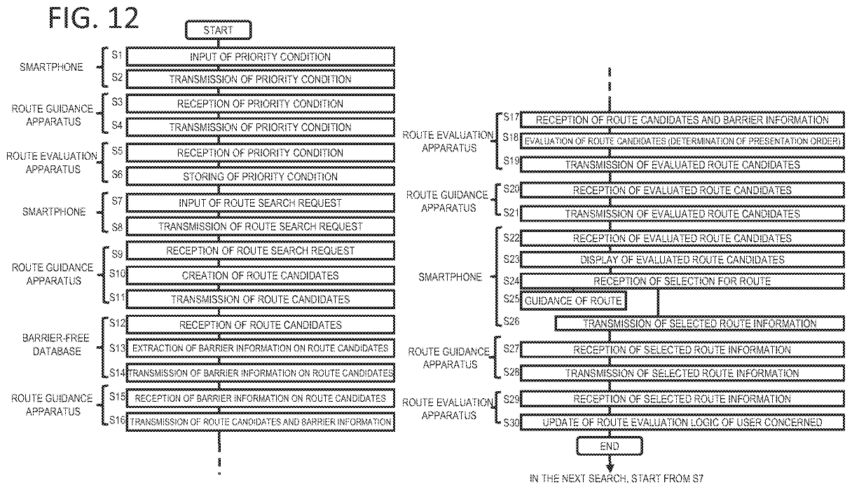

Next, operations in the present example embodiment are explained in detail while referring to drawings. FIG. 12 is a flowchart showing operations in the route guidance system of the first example embodiment of the present invention. Hereinafter, operations by each entity are explained along FIG. 12.

S1 (INPUT OF EVALUATION [sic, PRIORITY] CONDITION): A user previously inputs a priority condition for a route to an application on the smartphone 200.

The followings are considered as the priority condition. It is preferable that demands (items, clauses) may be set, such as, for example, in a case where a user has a handicap, in terms of floor-change movement over multiple floors, ELEVATOR-UTILIZING ONLY (ESSENTIAL); ELEVATOR- OR ESCALATOR-UTILIZING ONLY (NO STEPS/STAIRS-UTILIZING); ELEVATOR- OR ESCALATOR-UTILIZING PRIORITY, but STEPS/STAIRS-UTILIZING ACCEPTABLE (designation of acceptable movement distance/step-number, etc.). In addition, it is preferable that demands may be set in terms of over-step movement during horizontal direction movement, such as SLOPE-UTILIZING ONLY; SLOPE-UTILIZING PRIORITY but STEPS-UTILIZING ACCEPTABLE (designation of acceptable movement distance/steps, acceptable height of one-step, etc.). Further, it is preferable that demands may be set with respect to roads, such as NO-PEDESTRIAN BRIDGE UTILIZING; SLIGHT-STEP-DIFFERENCE AND PAVED ROAD MOST PRIORITIZED; NO-PEDESTRIAN BRIDGE UTILIZING and SLIGHT-STEP-DIFFERENCE AND PAVED ROAD PRIORITY (designation of acceptable movement distance, allowable height of step-difference, etc.); permission of pedestrian bridge-use (designation of acceptable movement distance, acceptable number of steps on a steps-section of a pedestrian bridge, etc.); NO-DEMANDS FOR STEP-DIFFERENCE AND ROAD SURFACE STATE, and the like. Of course, for healthy persons, too, it is preferable that ELEVATOR UTILIZING PRIORITY; ESCALATOR UTILIZING PRIORITY; STEPS UTILIZING PRIORITY; ROADS-WITH-SIDEWALK PRIORITY; etc., because the healthy persons would have various preference individually. In addition, non-selection condition may be set as the priority condition, such as NO-USE OF STEPS-UTILIZING ROUTE (prohibition), and the like.

S2 (TRANSMISSION OF PRIORITY CONDITION): The application on the smartphone 200 transmits the priority condition that is input in S1 and personal ID for identifying the user to the route guidance apparatus 100.

S3 (RECEPTION OF PRIORITY CONDITION): The route guidance apparatus 100 receives the personal ID and the priority condition that is transmitted in S2.

S4 (TRANSMISSION OF PRIORITY CONDITION): The route guidance apparatus 100 transmits the personal ID and the priority condition that is received in S3 to the route evaluation system [sic, apparatus].

S5 (RECEPTION OF PRIORITY CONDITION): The route evaluation apparatus 150 receives the personal ID and the priority condition that is transmitted in S4.

S6 (STORING OF PRIORITY CONDITION): The route evaluation apparatus 150 stores the personal ID and the priority condition that is received in S5 in the user database of the storage part 152.

The above processes are initial settings required for utilizing the route guidance system of the present example embodiment. Next, operations executed at every timing of route search are explained.

S7 (INPUT OF ROUTE SEARCH REQUEST): A user inputs a departure place and a destination place to the application on the smartphone 200. As described above, current position obtained from GPS on the smartphone 200 may be used as the departure place.

S8 (TRANSMISSION OF ROUTE SEARCH REQUEST): The application on the smartphone 200 attaches the personal ID to the departure place and the destination place that are input in S7 and transmits them to the route guidance apparatus 100.

S9 (RECEPTION OF ROUTE SEARCH REQUEST): The route guidance apparatus 100 receives the personal ID, the departure place and the destination place that are transmitted in S8.

S10 (CREATION OF ROUTE CANDIDATES): The route guidance apparatus 100 creates (searches) a plurality of routes to be presented to the user from the departure place and the destination place that are received in S9.

S11 (TRANSMISSION OF ROUTE CANDIDATES): The route guidance apparatus 100 transmits the route candidates that are created in S10 to the barrier-free database 300 so as to inquire the barrier information on the routes resulted as the route candidates.

S12 (RECEPTION OF ROUTE CANDIDATES): The barrier-free database 300 receives the route candidates that are transmitted in S11.

S13 (EXTRACTION OF BARRIER INFORMATION ON ROUTE CANDIDATES): The barrier-free database 300 extracts the barrier information for roads and facilities on the route candidates that are received in S12.

S14 (TRANSMISSION OF BARRIER INFORMATION ON ROUTE CANDIDATES): The barrier-free database 300 transmits the barrier information on the route candidates that is extracted in S13 to the route guidance apparatus 100.

S15 (RECEPTION OF BARRIER INFORMATION ON ROUTE CANDIDATES): The route guidance apparatus 100 receives the barrier information on the route candidates that is transmitted in S14.

S16 (TRANSMISSION OF ROUTE CANDIDATES AND BARRIER INFORMATION): The route guidance apparatus 100 transmits the personal information received in S9, the route candidates selected in S10 and the barrier information on the route candidates received in S15, to the route evaluation apparatus 150.

S17 (RECEPTION OF ROUTE CANDIDATES AND BARRIER INFORMATION): The route evaluation apparatus 150 receives the personal ID, the candidate routes and the barrier information that are transmitted in S16.

S18 (EVALUATION OF ROUTE CANDIDATES): The route evaluation apparatus 150 executes evaluation of the route candidates based on the priority condition matching with the personal ID and the barrier information received in S17. For example, the route candidates may be evaluated along the following processes.

(E1) Among the route candidates, routes passing a barrier (steps, etc.) which is designated as “NO-UTILIZING” in the priority condition are excluded. The contents designated as “NO-UTILIZING” in the priority condition functions as the non-selection condition.

(E2) Scores are determined for the remaining route candidates based on the degrees of satisfaction of the condition that is set in the priority condition input in S1. A route having the highest score among them is of the highest-evaluation. On the other hand, the route candidates that have a lower score(s) than the highest-evaluation route candidate, but provide a shorter distance(s) are (re-)arranged in the order of the scores (DETERMINATION OF PRESENTATION ORDER). Such rearrangement of the route candidates including the highest-evaluation route is referred to as “evaluation logic”.

S19 (TRANSMISSION OF EVALUATED ROUTE CANDIDATES): The route evaluation apparatus 150 transmits the personal ID received in S9 and the evaluated route candidates determined in S18 to the route guidance apparatus 100.

S20 (RECEPTION OF EVALUATED ROUTE CANDIDATES): The route guidance apparatus 100 receives the personal ID and the evaluated route candidates transmitted in S19.

S21 (TRANSMISSION OF EVALUATED ROUTE CANDIDATES): The route guidance apparatus 100 transmits the evaluated route candidates to the smartphone 200 identified by the personal ID received in S20.

S22 (RECEPTION OF EVALUATED ROUTE CANDIDATES): The application on the smartphone 200 receives the evaluated route candidates transmitted in S21.

S23 (DISPLAY OF EVALUATED ROUTE CANDIDATES): The application on the smartphone 200 displays, with respect to the evaluated route candidates received in S22, their routes on a map, distances, the degrees of matching with the priority condition, etc., for each route. As the degree of matching with the priority condition, the score described above may be used and also a ratio of demands that satisfy the condition relative to the demands which have been set.

S24 (RECEPTION OF SELECTION FOR ROUTE): The user selects a route from the route candidates displayed on the application on the smartphone 200.

S25 (GUIDANCE OF ROUTE): The application on the smartphone 200 starts route guidance based on the route that is selected.

S26 (TRANSMISSION OF SELECTED ROUTE INFORMATION): The application of the smartphone 200 attaches the personal ID to the information about the selected route and transmits it to the route guidance apparatus 100.

S27 (RECEPTION OF SELECTED ROUTE INFORMATION): The route guidance apparatus 100 receives the personal ID and the selected route information that are transmitted in S26

S28 (TRANSMISSION OF SELECTED ROUTE INFORMATION): The route guidance apparatus 100 transmits the personal ID and the selected route information that are received in S27 to the route evaluation apparatus 150.

S29 (TRANSMISSION OF SELECTED ROUTE [sic, ROUTE INFORMATION]): The route evaluation apparatus 150 receives the personal ID and the selected route information that are transmitted in S28.

S30 (UPDATE OF PRIORITY CONDITION): The route evaluation apparatus 150 changes the evaluation logic (E2) in the evaluation processes of above S18 identified by the personal ID received in S29 based on the selected route information received in S29.

Herein, the processes of updating the priority condition in the route evaluation apparatus 150 is explained.

(E11) In a case where the highest evaluation route is selected in S18, the route evaluation apparatus 150 does not update the route evaluation based on the priority condition. That is, a fact that the highest evaluation route is selected reveals that the route evaluation based on the current priority condition is pertinent.

(E12) In a case where a route other than the highest evaluation route is selected, the route evaluation apparatus 150 stores a demand(s) in the priority condition that is/are not satisfied by the route and a shortened distance. For example, in a case where a user who demands ELEVATOR-UTILIZING PRIORITY and ESCALATOR-UTILIZING ACCEPTABLE selects an escalator-utilizing route which is shorter than an elevator-utilizing route by a distance of 100 m, the route evaluation apparatus 150 stores the distance of 100 m in association with the demand ELEVATOR-UTILIZING PRIORITY in the priority condition.

(E13) The route evaluation apparatus 150 stores this distance as a threshold (“order change threshold” described later on) upon next and subsequent evaluation of the elevator-utilizing route and the escalator-utilizing route for a corresponding user. Herein, as the threshold, the latest value may be always used, or an average of distances accumulated over a predetermined past period may be used.

(E14) Upon the next and subsequent evaluations in S18, the route evaluation apparatus 150 selects a route candidate having the highest degree of satisfaction of the priority condition and a route candidate which had been selected in the past even though including demands that are not satisfied among the priority conditions. In addition, the route evaluation apparatus 150 compares the distance-difference from the route candidate having the highest degree of satisfaction of the priority condition and the stored threshold for the demand which is not satisfied so as to determine a higher one as the highest-evaluation route candidate.

Herein, the comparison in (E14) above may be executed on the entire route, and also executed by evaluating each of subdivided sections and then comparing total values thereof.

One example of change (update) of the evaluation logic (E2) in the evaluation processes of above S18 by the route evaluation apparatus 150 is explained as follows. In the following explanation, it is assumed that any one of 3 demands of ELEVATOR (PRIORITY, ACCEPTABLE, NO-USE), ESCALATOR (PRIORITY, ACCEPTABLE, NO-USE), STEPS (PRIORITY, ACCEPTABLE, NO-USE) may be designated as “PRIORITY”. In addition, as an initial state, it is assumed that “infinity” is automatically set as the threshold (order change threshold) for re-arrangement of the ranking based distance-difference between the ELEVATOR and the ESCALATOR, as well as between the ESCALATOR and the STEPS. Herein, “threshold (order change threshold)=infinity” means that re-arrangement is not executed.

(Case 1: A Case of User A)

Priority condition in S1: ELEVATOR-PRIORITY, ESCALATOR-ACCEPTABLE, NO STEPS/STAIRS-UTILIZING, order change threshold between an elevator-utilizing route and an escalator-utilizing route=infinity.

In the route creating process of S10, it is assumed that 2 routes of an elevator-utilizing route of 1000 m and an escalator-utilizing route of 950 m are created.

In such case, the elevator-utilizing route of 1000 m matches with the priority condition, thus results in the highest-evaluation route candidate. Therefore, in S23, the smartphone 200 presents (displays) the elevator-utilizing route of 1000 m, and the escalator-utilizing route of 950 m in this order.

When the user selects the escalator-utilizing route in S24, a threshold (order change threshold)=50 m is set. Thereby, upon subsequent route search, in comparison of an elevator-utilizing route with an escalator-utilizing route, the escalator-utilizing route is prioritized to the elevator-utilizing route under a situation where the escalator-utilizing route has a shorter distance by 50 m or more.

After that, it is assumed that, when User A executes another route search, 4 routes are created in the route create process of S10, including: an elevator-utilizing route of 1000 m; an escalator-utilizing route of 950 m; an escalator-utilizing route of 930 m; and a steps-utilizing route of 900 m. In such case, the steps-utilizing route is excluded from the route candidates in (E1), since NO STEPS/STAIRS-UTILIZING has been set. The escalator-utilizing route of 930 m is determined as the highest-evaluation route candidate, since it is the shortest route exceeding the order change threshold among the three remaining route candidates. Therefore, in S23, the smartphone 200 presents the escalator-utilizing route of 930 m, the escalator-utilizing route of 950 m, the elevator-utilizing route of 1000 m in this order. Herein, even if a steps-utilizing route is found in this search process, it is excluded from the route candidates in (E1), since NO STEPS/STAIRS-UTILIZING has been set.

On the other hand, it is assumed that, when User A executes another route search, 2 routes are created in the route create process of S10, including an elevator-utilizing route of 950 m, and an escalator-utilizing route of 930 m. In such case, the elevator-utilizing route 950 m is determined as the highest evaluation, since the distance-difference between them<the order change threshold.

Thus in addition, if the user selects escalator-utilizing route in S24, the distance-difference is reflected to the threshold. For example, as described above, the order change threshold results in 35 m due to (50 m+20 m)/2 for the order change threshold. Thereby, upon subsequent route search, in comparison of an elevator-utilizing route with an escalator-utilizing route, the escalator-utilizing route is prioritized to the elevator-utilizing route under a situation where the escalator-utilizing route has a shorter distance by 35 m or more. As described above, a statistic value (average value) of the distance-differences in past cases where the highest evaluation route is not selected may be used as the order change threshold.

Herein, in a case where there are multiple elements included in the barrier elements on a route presented as the route candidates, such as an elevator, an escalator, steps, etc., defined as the priority condition, the value reflected to the order change threshold may be proportionally distributed considering the number of the barrier elements.

For example, it is also supposed that there are multiple elevators, escalators on a route as a result of execution by the User A of route search from a DEPARTURE PLACE: C to a DESTINATION PLACE: D. From DEPARTURE PLACE: C to DESTINATION PLACE: D

Route 1 Elevators×3 1000 m (the highest evaluation)

Route 2 Escalator×3 750 m

Herein, in a case where User A selects route 2, the distance-difference between Route 1 and Route 2 is 250 m. For example, the current order change threshold of 35 m may be updated by the following expression. Herein, 3 as a denominator is a value considered that there are 3 escalators thereon.

(35 m+250 m)/(1+3)=71.25 m

Thereby, upon subsequent route search, in comparison between an elevator-utilizing route and an escalator-utilizing route, an escalator-utilizing route is prioritized to the elevator-utilizing route under a situation where the escalator-utilizing route has a shorter distance by 71.25 m or more.

For example, it is assumed that when User A executes another route search, 4 routes are created in the route create process of S10, including an elevator-utilizing route of 1000 m, escalator-utilizing routes of 950 m; 920 m, and a steps-utilizing route of 900 m. In such case, due to the order change threshold, the escalator-utilizing route is determined as the highest evaluation route, since there is the distance-difference of 80 m between the elevator-utilizing route 1000 and the escalator-utilizing route of 920 m, even though the elevator-utilizing route 1000 has a higher degree of satisfaction of the priority condition. In addition, the second is the elevator-utilizing route of 1000 m having a higher degree of satisfaction of the priority condition, and the third is the escalator-utilizing route 950 m. Herein the steps-utilizing route is excluded, since being designated as “NO-UTILIZING” in its demand of the priority condition.

As explained above, according to the present example embodiment, by virtue of the present invention, an optimal route may be selected depending on property of each user, such as handicap, limitations in muscle power, physical strength, etc., behavior pattern and the like. The reason for such optimal route selection resides in that a configuration is adopted, in which evaluation (re-arrangement of ranking) is executed based on actual route selection by each person.

As described above, although each example embodiment of the present invention is explained, the present invention is not limited to the above described example embodiments. Further deformation, substitution, adjustment may be applied within a scope of a basic technical concept of the present invention. For example, the network configuration, the configuration of each element, and the expression mode of the message illustrated in each drawing are an example of explanatory aid for understanding the present invention, thus not limited to the configuration(s) illustrated in these drawings.

For example, comparison of entire routes is executed in the example embodiment described above. However, a method may be adopted, comparison and evaluation are executed while excluding common sections between 2 routes. For example, in a case where Route 1 and Route 2 are obtained as a result of route search based on DEPARTURE PLACE: A and DESTINATION PLACE: E as indicated below, creation of ranking based on the degree of satisfaction of the priority condition and the distance-difference may be executed for the section from place: B to place: E, since the section from place: A to place: B is common.

Route 1 place: A⇒place: B⇒place: C⇒place: E

Route 2 place: A⇒place: B⇒place: D⇒place: E

Further, in the example embodiments described above, a configuration may be also adopted, in which the route search part 12 also searches an alternative route(s) on which a similar facility until the destination place input from the smartphone 200 is present and adds the same to candidate(s) for evaluation. In such case, it will result in that the route evaluation apparatus 150 also adds the alternative route(s) to the evaluation target(s).

In addition, in the example embodiments described above, a configuration may be also adopted, in which an additional setting is accepted as a new priority condition, for instance, in a case of update of information that may be obtained from the barrier-free database 300. As such addition, the following methods are considered: the route evaluation apparatus 150 automatically and additionally sets an initial value to the priority condition, or inquires a user of necessity of additional registration and then accepts a setting of the priority condition.

Any or all of functions of the route guidance apparatus 100, the route evaluation apparatus 150, the barrier-free database 300 may be realized in the smartphone 200. Therefore, the above described route guidance system may be realized by a single smartphone.

In addition, in the above described route evaluation logic, the route evaluation apparatus 150 may additionally obtain situation, such as surrounding environment and the like (example: weather, etc.) so as to execute evaluation depending on the surrounding environment. For example, in a case of rain, a route for avoiding being drenched with rain may be guided under a configuration where a condition ROUTE-WITH-ROOF PRIORITY may be set as the priority condition. Alternatively, a method may be also adopted, in which, in a case where a route having a shorter distance but including a section having a possibility of being drenched with rain is selected, the distance-difference therebetween is utilized as the order change threshold.

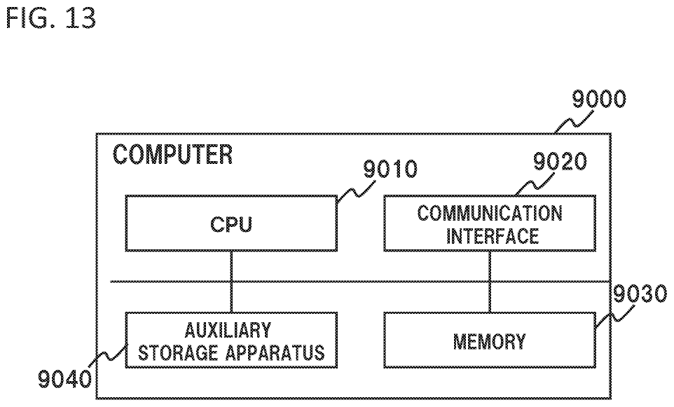

Furthermore, the processes described in the above first example embodiment may be realized by a program that causes a computer (FIG. 13, 9000) configuring the route guidance system 10a to realize functions of each of parts of the route guidance system 10a. Such computer is exemplified by a configuration comprising a CPU (Central Processing Unit) 9010, a communication interface 9020, a memory 9030, an auxiliary storage apparatus 9040 in FIG. 13. That is, the CPU 9010 in FIG. 13 may execute route search program and route evaluation program so as to execute update process for each calculation parameter stored in auxiliary storage apparatus 9040, etc.

That is, each of parts (processing means, functions) of the route guidance system 10a described in the above first example embodiment may be realized by a computer program that causes a processor installed in a configuration apparatus of the route guidance system 10a to execute each of the above described processes using its hardware.

Last, preferred modes of the present invention are summarized.

[First Mode]

(see the route guidance system according to the above first aspect)

[Second Mode]

The above route guidance system may adopt a configuration, in which, in a case where the route that does not match with the priority condition is selected, the distance-difference between the distance of the route that matches with the priority condition and the distance of the route that is selected is stored for each of users, and a statistic value of the stored distance-difference is utilized as the weight information of the priority condition.

[Third Mode]

The above route guidance system may adopt a configuration, in which, as the priority condition, at least one route of an elevator-utilizing route, an escalator-utilizing route, a steps-utilizing route, or a slope-utilizing route may be set.

[Fourth Mode]

The route evaluation part of the above route guidance system may adopt a configuration to refer to a database storing placement information about an elevator, an escalator, steps and a slope on the map so as to determine whether, or not, the route matches with the priority condition.

[Fifth Mode]

The above route guidance system may be also so configured that a non-selection condition defining a condition of not-selecting a route may be set, and the route evaluation part excludes a route that matches with the non-selection condition from evaluation target(s).

[Sixth Mode]

The route search part of the above route guidance system may be also so configured to search an alternative route on which a similar facility until the destination place from the terminal is present, and add the same to candidate(s) for evaluation by the route evaluation part.

[Seventh Mode]

(See the terminal according to the above second aspect)

[Eighth Mode]

(See the route guidance method according to the above third aspect)

[Ninth Mode]

(See the program according to the above fourth aspect)

Herein, the seventh to ninth modes may be developed to the second to sixth modes like as the first mode.

Herein, the disclosures of the above Patent Literatures are incorporated herein by reference thereto. Variations and adjustments of the example embodiments are possible within the ambit of the entire disclosure (including the claims) of the present invention and based on the basic technical concept of the present invention. Various combinations and selections (including non-selection) of various disclosed elements (including each element in each claim, each example embodiment, each drawing, etc.) are possible within the ambit of the disclosure of the present invention. Namely, the present invention of course includes various variations and modifications that could be made by those skilled in the art according to the overall disclosure including the claims and the technical concept. Particularly, a numerical value range described in the present description should be interpreted as describing arbitrary numerical values or small ranges included in the ranges, even if they are not described explicitly. Further, each of the disclosed matters of the above cited literatures is regarded as included in the described matters in the present application, if required, on the basis of the concept of the present invention, as a part of description of the present invention, also that a part or entire thereof is used in combination with a described matter(s) in the present application.

### REFERENCE SIGNS LIST

10, 10a route guidance system
11 setting reception part
11a user interface part
12 route search part
13 route evaluation part
14 guidance part
15 navigation map storing part
20 terminal
100 route guidance apparatus
150 route evaluation apparatus
151 route evaluation part
152 storage part
200 smartphone
300 barrier-free database
9000 computer
9010 CPU
9020 communication interface
9030 memory
9040 auxiliary storage apparatus

What is claimed is:

1. A route guidance system, comprising:
at least a processor; and
a memory in circuit communication with the processor;
wherein the processor is configured to execute program instructions stored in the memory to implement:
a setting reception part that receives a setting of a priority condition for a route other than the distance of the route from a user terminal;
a route search part that searches a plurality of routes allowing to reach a destination place from a departure place based on map information including a map for route calculation, and the departure place and the destination place that are input from the terminal;
a route evaluation part that determines whether, or not, the searched route matches with the priority condition so as to present, side-by-side, a route(s) that matches with the priority condition and a route(s) that does not match with the priority condition; and
a guidance part that receives selection of a route from the terminal so as to execute route guidance; wherein
in a case where a route that does not match with the priority condition among the presented routes is selected, the route evaluation part stores, as weight information of the priority condition, a distance-difference between a distance of the route that matches with the priority condition and a distance of the selected route, and
the route evaluation part presents, upon presenting a route at the next and subsequent timings, a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

2. The route guidance system according to claim 1, wherein
in a case where the route that does not match with the priority condition is selected, the distance-difference between the distance of the route that matches with the priority condition and the distance of the route that is selected is stored for each of users, and
a statistic value of the stored distance-difference is utilized as the weight information of the priority condition.

3. The route guidance system according to claim 1, wherein
as the priority condition, at least one route of an elevator-utilizing route, an escalator-utilizing route, a steps-utilizing route, or a slope-utilizing route may be set.

4. The route guidance system according to claim 1, wherein
the route evaluation part refers to a database storing placement information about an elevator, an escalator, steps and a slope on the map so as to determine whether, or not, the route matches with the priority condition.

5. The route guidance system according to claim 1, wherein
a non-selection condition defining a condition of not-selecting a route may be set, and
the route evaluation part excludes a route that matches with the non-selection condition from evaluation target(s).

6. The route guidance system according to claim 1, wherein
the route search part also searches an alternative route on which a similar facility until the destination place from the terminal is present, and adds the same to candidate(s) for evaluation by the route evaluation part.

7. A terminal, comprising:
at least a processor; and
a memory in circuit communication with the processor;
wherein the processor is configured to execute program instructions stored in the memory to implement:
a setting reception part that receives a setting of a priority condition for a route other than the distance of the route from a user;
a route search part that searches a plurality of routes allowing to reach a destination place from a departure place based on map information including a map for route calculation, and the departure place and the destination place that are input from the user;
a route evaluation part that determines whether, or not, the searched route matches with the priority condition so as to present, side-by-side, a route(s) that matches with the priority condition and a route(s) that does not match with the priority condition; and
a guidance part that receives selection of a route from the user so as to execute route guidance; wherein
in a case where a route that does not match with the priority condition among the presented routes is selected, the route evaluation part stores, as weight information of the priority condition, a distance-difference between a distance of the route that matches with the priority condition and a distance of the selected rout, and
the route evaluation part presents, upon presenting a route at the next and subsequent timings, a route in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

8. A route guidance method, comprising:
receiving a setting of a priority condition for a route other than the distance of the route from a user;
searching a plurality of routes allowing to reach a destination place from a departure place based on map information including a map for route calculation, and the departure place and the destination place that are input from the user;
determining whether, or not, the searched route matches with the priority condition so as to present, side-by-side, a route(s) that matches with the priority condition and a route(s) that does not match with the priority condition;
receiving selection of a route from a user so as to execute route guidance; and
storing, in a case where a route that does not match with the priority condition among the presented routes is selected, as weight information of the priority condition, a distance-difference between a distance of the route that matches with the priority condition and a distance of the selected route; wherein
upon presenting a route at the next and subsequent timings, a route is presented in a mode where the route that does not match with the priority condition is recommended rather than the route that matches with the priority condition in a case where the distance-difference between the distance of the route that matches with the priority condition and the distance of the route that does not match with the priority condition exceeds a distance stored as the weight information.

9. (canceled)

10. The terminal according to claim 7, wherein
in a case where the route that does not match with the priority condition is selected, the distance-difference between the distance of the route that matches with the priority condition and the distance of the route that is selected is stored for each of users, and
a statistic value of the stored distance-difference is utilized as the weight information of the priority condition.

11. The terminal according to claim 7, wherein
as the priority condition, at least one route of an elevator-utilizing route, an escalator-utilizing route, a steps-utilizing route, or a slope-utilizing route may be set.

12. The terminal according to claim 7, wherein
the route evaluation part refers to a database storing placement information about an elevator, an escalator, steps and a slope on the map so as to determine whether, or not, the route matches with the priority condition.

13. The terminal according to claim 7, wherein
a non-selection condition defining a condition of not-selecting a route may be set, and
the route evaluation part excludes a route that matches with the non-selection condition from evaluation target(s).

14. The terminal according to claim 7, wherein
the route search part also searches an alternative route on which a similar facility until the destination place from the terminal is present, and adds the same to candidate(s) for evaluation by the route evaluation part.

15. The route guidance method according to claim 8, wherein
in a case where the route that does not match with the priority condition is selected, the distance-difference between the distance of the route that matches with the priority condition and the distance of the route that is selected is stored for each of users, and
a statistic value of the stored distance-difference is utilized as the weight information of the priority condition.

16. The route guidance method according to claim 8, wherein
as the priority condition, at least one route of an elevator-utilizing route, an escalator-utilizing route, a steps-utilizing route, or a slope-utilizing route may be set.

17. The route guidance method according to claim 8, further comprising
referring to a database storing placement information about an elevator, an escalator, steps and a slope on the map so as to determine whether, or not, the route matches with the priority condition.

18. The route guidance method according to claim 8, wherein
a non-selection condition defining a condition of not-selecting a route may be set, and
the route guidance method further comprising: excluding a route that matches with the non-selection condition from evaluation target(s).

19. The route guidance method according to claim 8, further comprising:
searching an alternative route on which a similar facility until the destination place from the terminal is present, and adds the same to candidate(s) for the evaluation.
